(19) United States
(12) Patent Application Publication
(10) Pub. No.: US 2011/0217067 A1
(43) Pub. Date: Sep. 8, 2011

(54) TONER CARTRIDGE

(75) Inventors: Yoshiaki Tokuno, Kanagawa (JP); Takafumi Amano, Kanagawa (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/032,726

(22) Filed: Feb. 23, 2011

Related U.S. Application Data
(60) Provisional application No. 61/309,944, filed on Mar. 3, 2010.

(51) Int. Cl. G03G 15/00

(52) U.S. Cl. 399/110

(57) ABSTRACT

A toner cartridge includes a toner cartridge main body having a cylindrical toner container that contains toner therein, a toner discharge port disposed on one end of the toner container, and a rotating shaft disposed on the other end of the toner container; and an annular IC chip holder that is fitted to the rotating shaft of the toner cartridge main body to rotate together with the toner cartridge main body, and has a notch formed in an outer peripheral surface in which an IC chip is mounted, wherein the IC chip holder rotates together with the toner cartridge main body until the IC chip holder is fixed to an IC chip contact holder having a contact member for contacting a terminal of the IC chip disposed in the image forming apparatus main body.

### CROSS-REFERENCE TO RELATED APPLICATION

This application is based upon and claims the benefit of priority from provisional U.S. Patent Application 61/309,944 filed on Mar. 3, 2010, the entire contents of which are incorporated herein by reference.

### FIELD

The present invention relates generally to a toner cartridge that replenishes a developing device with toner in an image forming apparatus such as a copying machine or a printer, and the image forming apparatus using the toner cartridge.

### BACKGROUND

An image forming apparatus has a toner cartridge for replenishing a developing device with toner. The toner cartridge is detachably attached to the image forming apparatus, and can be replaced with a fresh one by a user per se when toner within the cartridge is used up. In the replacement cartridge of this type, for example, dedicated toner cartridges (hereinafter referred also to “genuine cartridges”) for image forming apparatuses sold by each manufacturer are set from the viewpoint of print quality. With use of such dedicated toner cartridges, toner optimally compounded can be supplied to the developing device so that the highest performance of the image forming apparatus is exercised to produce a printed material.

Incidentally, up to now, the above-mentioned replacement toner cartridge is equipped with a toner cartridge substrate. An IC chip is incorporated into the substrate, and, for example, control data intended to optimize an image according to identification information of the cartridge and the characteristics of toner is written in the IC chip. On the other hand, an image forming apparatus main body is equipped with a cartridge interface substrate. When the above-mentioned toner cartridge is loaded into the image forming apparatus main body, the cartridge side IC chip is always in contact with the main body side cartridge interface substrate.

During the operation of the image forming apparatus, information is mutually exchanged between the cartridge and the main body. For example, the main body side detects whether the cartridge is genuine, or not, accumulates the number of used sheets (or toner motor rotating time), and registers use cumulative information in a mode completion in the IC chip of the cartridge.

The configuration and capacity of the toner cartridge are infinite in variety. However, in an MFP (multi-function printer) of a high speed model, for the purpose of increasing the toner capacity, not a cartridge of a fixedly-mounted type, but, for example, a cylindrical cartridge of a bottle type (hereinafter referred also to “toner bottle”) is used. In the cartridge of this type, even if the toner bottle main body is equipped with the IC chip, because the overall toner bottle rotates at the time of replenishing toner, the IC chip cannot be always in contact with a main body side cartridge interface substrate (hereinafter referred also to “electronic substrate”). As a result, exchange of the above-mentioned information becomes insufficient.

### BRIEF DESCRIPTION OF THE DRAWINGS

The accompanying drawings, which is incorporated in and constitute a part of this specification, illustrates an embodiment of the invention and together with the description, server to explain the principles of the invention.

FIG. 1 is a cross-sectional view illustrating a rough configuration of an image forming apparatus in which a toner cartridge according to this embodiment is used;

FIG. 2A is a perspective view illustrating a toner cartridge according to a first embodiment;

FIG. 2B is a partial front view illustrating a toner cartridge in which an IC chip holder is attached to a toner container in FIG. 2A;

FIG. 2C is a cross-sectional view of FIG. 2B;

FIG. 3 is a configuration diagram illustrating a main portion of a replenishing device viewed from an arrow A in FIG. 1;

FIG. 4 is a perspective view illustrating a pressing part in FIG. 3;

FIGS. 5A, 5B, and 5C are diagrams illustrating operation mechanisms of the toner cartridge and a contact holder;

FIG. 6A is a perspective view illustrating a toner cartridge according to a second embodiment;

FIG. 6B is a partial front view illustrating a toner cartridge in which a peripheral ring is fitted to a toner container in FIG. 6A;

FIG. 6C is a cross-sectional view of FIG. 6B; and

FIGS. 7A and 7B are diagrams illustrating operation mechanisms of the toner cartridge and the contact holder.

### DETAILED DESCRIPTION

Reference will now be made in detail to the present embodiment of the invention, an example of which is illustrated in the accompanying drawing.

According to this embodiment, there is provided a toner cartridge including a toner cartridge main body having a cylindrical toner container that contains toner therein, a toner discharge port disposed on one end of the toner container, and a rotating shaft disposed on the other end of the toner container; and an annular IC chip holder that is fitted to the rotating shaft of the toner cartridge main body to rotate together with the toner cartridge main body, and has a notch formed in an outer peripheral surface in which an IC chip is mounted, wherein the IC chip holder rotates together with the toner cartridge main body until the IC chip holder is fixed to an IC chip contact holder having a contact member for contacting a terminal of the IC chip disposed in the image forming apparatus main body.

Also, according to this embodiment, there is provided a toner cartridge for use in an image forming apparatus, wherein a member of another piece that does not rotate integrally with the toner container is disposed on an outer periphery, and the IC chip of the toner cartridge can be always in contact with the main body side interface substrate even when the bottle rotates during replenishing toner.

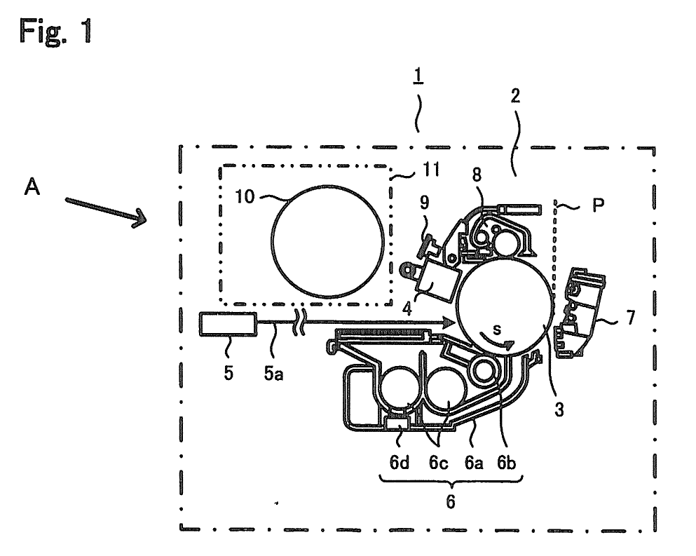

Hereinafter, this embodiment will be described with reference to FIGS. 1 to 8. In the following description, the same symbols denote components having the identical configurations and functions.

FIG. 1 is a diagram illustrating a rough configuration of an image forming part 2 in an image forming apparatus 1 according to this embodiment. Around a photosensitive drum 3 in the image forming part 2 are arranged a charging unit 4 that uniformly sequentially charges the photosensitive drum 3 with rotation of the photosensitive drum 3 in a direction of an arrow s, an exposure unit 5 that irradiates a laser beam 5a for forming a latent image on the charged photosensitive drum 3, a developing device 6 that supplies toner to the formed latent image, a transfer and peeling charger 7 that transfers a toner image formed on the photosensitive drum 3 to a transfer medium, a cleaner 8 that removes untransferred toner from the photosensitive drum 3, and a neutralization lamp 9 that removes electric charges from the photosensitive drum 3.

The developing device 6 is a known developing device of a magnetic brush system which performs development by the aid of a two-component developer containing toner and carrier. A development roller 6b, a transport auger 6c, and a toner concentration sensor 6d are disposed within a development container 6a. The developing device 6 further includes a toner replenishing part 11 that replenishes the developing device 6 with toner from a toner cartridge 10 according to a toner concentration in the developer, which is detected by the toner concentration sensor 6d, at a side end of the image forming apparatus 1.

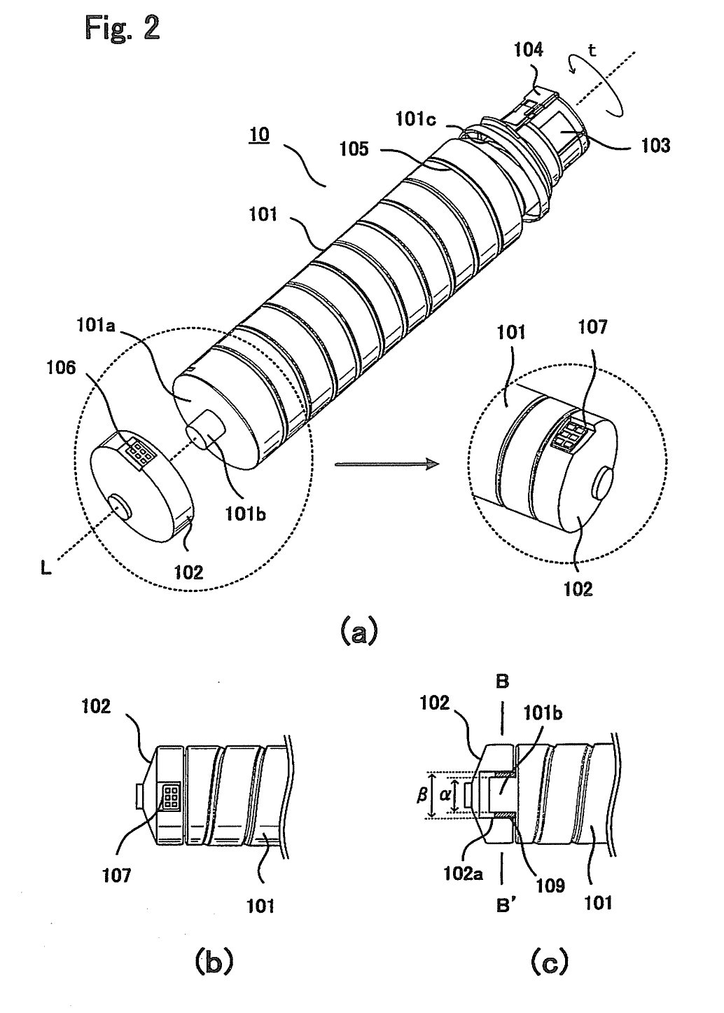

As illustrated in FIG. 2A, the toner cartridge 10 includes a toner container 101 that contains toner therein as a main body, and an IC chip holder 102. The IC chip holder 102 is attached to one end of the toner container 101, and a cylindrical cap part 103 is attached to the other end of the toner container 101. The cap part 103 is equipped with a toner supply part 104 for supplying toner within the toner container 101 to the toner replenishing part 11. The toner cartridge 10 is installed in the toner replenishing part 11, and rotates (as indicated by an arrow t) about an axis (a dotted line L) extending in a longitudinal direction thereof to replenish the developing device 6 with toner.

The toner container 101 is of a substantially cylindrical configuration with a bottom, and a helical protrusion for transporting toner is formed on at least an inner peripheral surface of the toner container 101, and a helical groove 105 corresponding to the helical protrusion is formed in an outer peripheral surface thereof. Toner filled in the toner container 101 in advance is gradually sent to the cap part 103 side with the help of the helical groove 105 with rotation of the toner container 101. Toner is then sent from the toner supply part 104 of the cap part 103 to the developing device 6.

A bottom 101a of the toner container 101 has a rotating shaft 101b of a cylindrical configuration smaller than an outer diameter of the toner container 101, for attaching the IC chip holder 102. On the other hand, a top 101c of the toner container 101 is smaller than a diameter of the toner container 101. An outer surface of the top 101c to be connected with the cap part 103 is so threaded as to be engaged with a threaded inner surface of the cap part 103. Those threads are reverse to each other so that the cap part 103 is not detached from the top 101c due to rotation. The toner container 101 and the cap part 103 may be integrated with each other.

The IC chip holder 102 is of a cylindrical configuration (annular shape) having substantially the same diameter as an outer diameter of the toner container 101, and a substantially L-shaped notch 107 in which an IC chip 106 is located is formed in an outer surface of the IC chip holder 102. A fitting part 102a having a diameter (an arrow β) larger than a diameter (an arrow α) of the rotating shaft 101b is provided in the center of the IC chip holder 102. The rotating shaft 101b and the fitting part 102a are fitted to each other through a torque limiter 108. The toner container 101 and the IC chip holder 102 freely rotate about the axial line (dotted line L) in the longitudinal direction relative to each other. Also, the IC chip holder 102 is detachably attached to the toner container 101 in a direction of the axial line (dotted line L) in the longitudinal direction (FIGS. 2B and 2C).

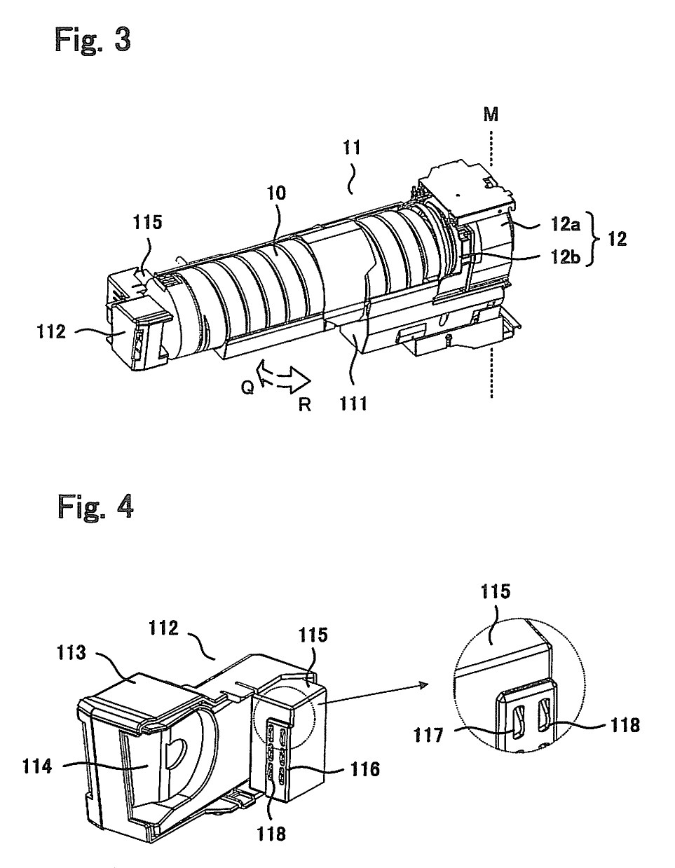

As illustrated in FIG. 3, the toner replenishing part 11 includes a cartridge holding part 111 that detachably holds the toner cartridge 10, a toner cartridge drive part 12 that rotationally drives the toner cartridge 10 about an axis thereof, and a cartridge pressing part 112 that presses the toner cartridge 10 toward the toner cartridge drive part 12.

The cartridge holding part 111 is rotatably supported about a portion connected with the image forming apparatus 1 as an axis (dotted line M) (arrows Q, R). The toner cartridge 10 is attached or detached by using the rotating operation (arrows Q, R) of the cartridge holding part 111. Specifically, if the toner cartridge 10 is loaded in the image forming apparatus 1, after the user holds the toner cartridge 10 in the cartridge holding part 111, the user rotates the cartridge holding part 111 in a direction of an arrow Q. On the other hand, if the toner cartridge 10 is removed, the user rotates the cartridge holding part 111 in a direction of an arrow R, and projects the cartridge holding part 111 to an outside of the image forming apparatus 1.

The toner cartridge drive part 12 includes a drive part main body 12a and a coupling 12b, and is disposed in the vicinity of a coupling part of the toner replenishing part 11. The coupling 12b is cylindrical, and a bottom of the coupling 12b has a convexo-concave part formed to be fitted to a convexo-concave part formed on a top of the cap part 103.

As illustrated in FIG. 4, the cartridge pressing part 112 includes a fixed part 113 fixed to the image forming apparatus 1, and a pressing part 114. An urging member such as a spring is disposed between the fixed part 113 and the pressing part 114, and urged in a direction of the toner cartridge 10. Also, the fixed part 113 includes an IC chip contact holder 115 with a cartridge interface substrate.

The IC chip contact holder 115 has a step 116 for fixing the IC chip holder 102. The step 116 has slits 117, and contact members 118 such as contact springs for contacting electrodes of the IC chip 106 located in the IC chip holder 102 are projected from the slits 117. The contact members 118 are covered with an insulating member except for a portion contacting the electrodes of the IC chip 106, connects with the cartridge interface substrate, and exchange information about the toner cartridge 10 with the image forming apparatus 1 main body through the cartridge interface substrate.

With the configuration described above, the toner cartridge 10 rotates upon receiving a drive force from the image forming apparatus 1. The IC chip holder 102 rotates together with rotation of the toner container 101 by means of the torque limiter 108. Thereafter, if a given load or more is applied to the IC chip holder 102, the IC chip holder 102 runs over with respect to rotation of the toner container 101.

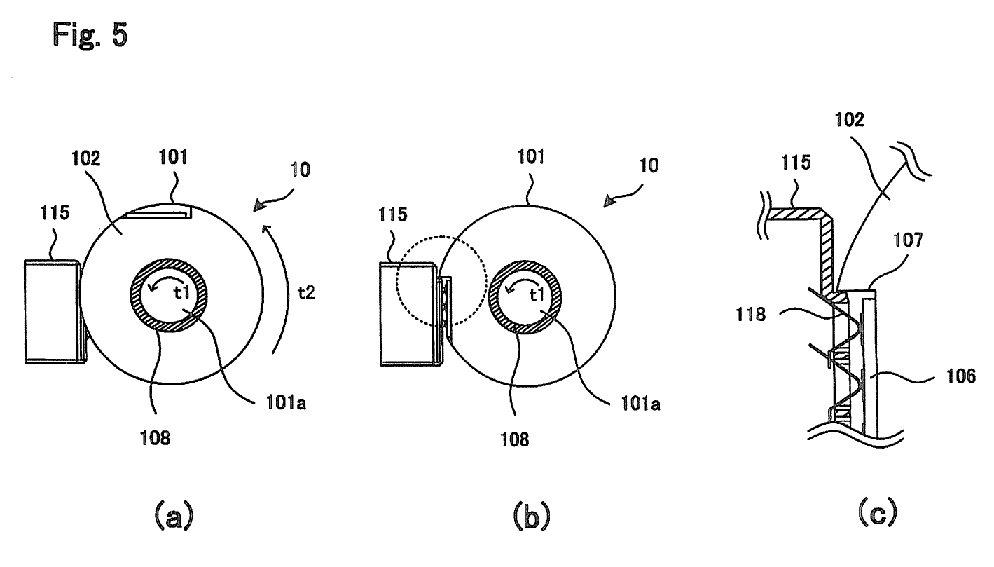

Specifically, the toner container 101 first rotates by a given amount when the user exchanges the toner cartridge 10 with a fresh one (FIG. 5A; an arrow t1), and the IC chip holder 102 also rotates together with rotation of the toner container 101 (FIG. 5A; an arrow t2). Thereafter, the notch 107 in which the IC chip 106 is located on the IC chip holder 102 arrives at the step 116, and is then locked (caught). At the same time, the contact members 118 contacts the IC chip 106 (FIG. 5C). The IC chip holder 102 is fixed at a locked position, runs over with respect to rotation of the toner container 101, and thereafter only the toner container 101 continuously rotates (FIG. 5B; an arrow t1). In FIGS. 5A and 5B, the toner cartridge 10 is illustrated by across section along a chain line B-B′ of FIG. 2C.

When the IC chip holder 102 is thus fixed at the above-mentioned locked position with the help of the notch 107 and the step 116 of the IC chip contact holder 115, the electrodes of the IC chip 106 always contact the contact members 118. In this situation, information is always exchanged between the main body side and the toner cartridge.

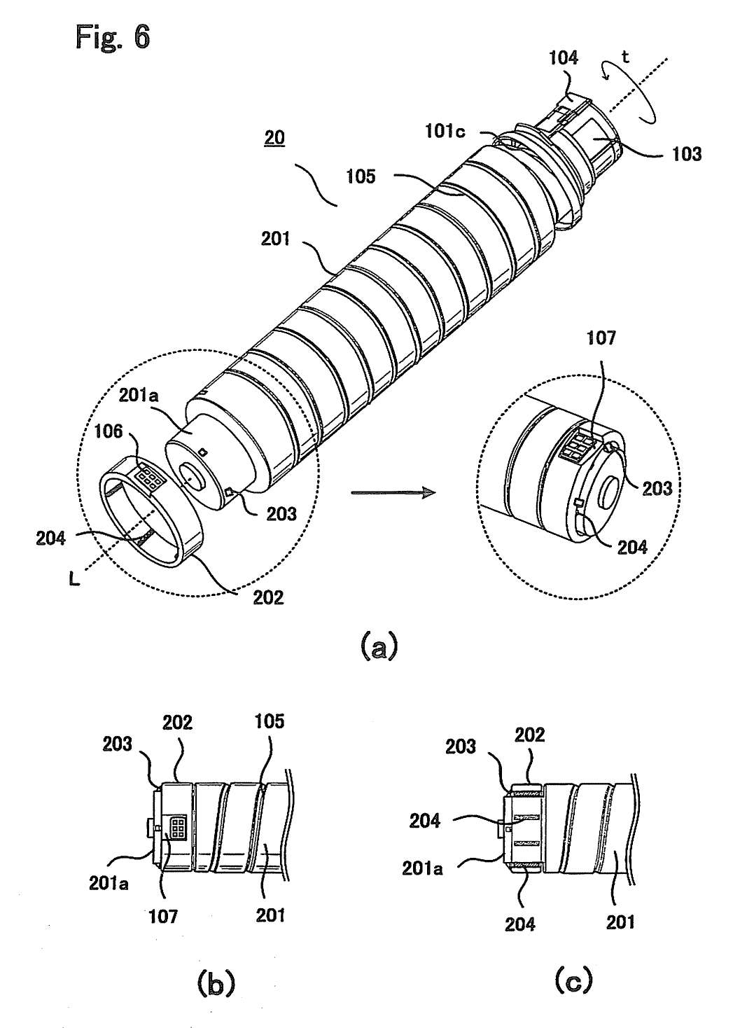

Subsequently, a toner cartridge 20 according to a second embodiment will be described with reference to FIG. 6. The toner cartridge 20 can be filled with toner more than that in the toner cartridge 10 of the first embodiment. In the following description, the same parts as those in the toner cartridge 10 of the first embodiment will be omitted from description.

The toner cartridge 20 according to this embodiment includes a toner container 201 that contains toner therein as a main body, and an outer peripheral ring 202 as an IC chip holder. The toner container 201 includes a bottom 201a having a diameter smaller than that of the toner container 201 by one step.

The bottom 201a has the same function as that of the rotating shaft 101b in the toner cartridge 10. Also, the bottom 201a is provided with projections 203 for supporting an outer peripheral ring 202 attached thereto so as not to be removed. The interiors of the toner container 201 and the bottom 201a communicate with each other.

The outer peripheral ring 202 is disposed on an outer peripheral surface of the bottom 201a so as to be slidable (detachable) along an axial direction. The outer peripheral ring 202 has the notch 107 in which the IC chip 106 is located as with the IC chip holder 102 in the toner cartridge 10. Contact members 204 such as brushes or plate springs are attached to an inner wall of the outer peripheral ring 202, and the outer peripheral ring 202 is attached to the bottom 201a through the contact members 204.

With the above configuration, the toner cartridge 20 can be filled with much toner for the bottom 201a as compared with the toner cartridge 10.

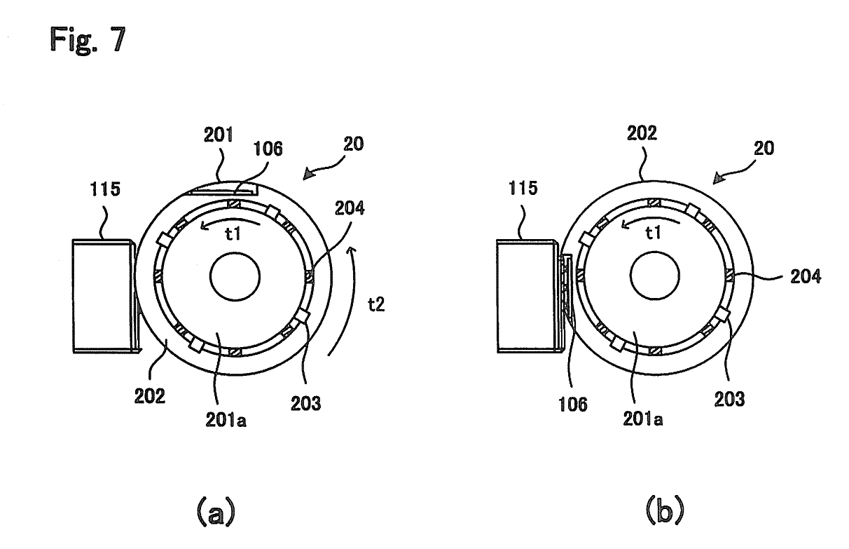

The installation location of the outer peripheral ring 202 is not particularly limited, but is preferably a position farthest from the toner supply part 104, that is, a bottom of the toner container 201 illustrated in FIG. 7, from the viewpoint of preventing fly toner from being attached to the IC chip 106.

A specific operation mechanism of the toner cartridge 20 will be described with reference to FIG. 7. First, when the user exchanges the toner cartridge 20 with a fresh one, the toner container 201 rotates by a given amount, and the outer peripheral ring 202 also rotates together with rotation of the toner container 201 (FIG. 7A; arrows t1 and t2). Thereafter, the notch 107 in which the IC chip 106 is located on the outer peripheral ring 202 arrives at the step 116 of the IC chip contact holder 115, and is then locked (caught). At the same time, the contact members 118 contacts with the IC chip 106. The outer peripheral ring 202 is fixed at a locked position, runs over with respect to rotation of the toner container 201, and thereafter only the toner container 101 continuously rotates (FIG. 7B; the arrow t1).

As described above, according to this embodiment, even if the toner cartridge is rotating when toner is replenished, the IC chip of the toner cartridge can always contact the main body side cartridge interface substrate, and information can be exchanged between the toner cartridge and the image forming apparatus main body.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions the accompanying claims and their equivalents are intended to cover such forms or modifications as would fall within the scope and spirit of the inventions.

What is claimed is:

1. A toner cartridge, comprising:
a toner cartridge main body having a cylindrical toner container that contains toner therein, a toner discharge port disposed on one end of the toner container, and a rotating shaft disposed on the other end of the toner container; and
an annular IC chip holder that is fitted to the rotating shaft of the toner cartridge main body to rotate together with the toner cartridge main body, and has a notch formed in an outer peripheral surface in which an IC chip is mounted, wherein
the IC chip holder rotates together with the toner cartridge main body until the IC chip holder is fixed to an IC chip contact holder having a contact member for contacting a terminal of the IC chip disposed in the image forming apparatus main body.

2. The cartridge according to claim 1, wherein
a helical protrusion is formed on an inner peripheral surface of the toner container so that toner in the toner container moves toward the toner discharge port due to rotation of the toner cartridge.

3. The cartridge according to claim 1, wherein
the notch of the annular IC chip holder is substantially L-shaped in a cross section perpendicular to a rotating shaft of the toner cartridge.

4. The cartridge according to claim 1, wherein
the IC chip holder is attached to a rotating shaft of the toner container through a torque limiter.

5. A toner cartridge, comprising:
a toner cartridge main body including a cylindrical toner container that contains toner therein, a toner discharge port provided at one end of the toner container, and a rotating shaft disposed at the other end of the toner container, in which an interior of the rotating shaft is hollow, and communicates with an interior of the toner container; and
an annular IC chip holder that is fitted to the rotating shaft of the toner cartridge main body to rotate together with the toner cartridge main body, and has a notch formed on an outer periphery thereof in which an IC chip is mounted, wherein
the IC chip holder rotates together with the toner cartridge main body until the IC chip holder is fixed to an IC chip contact holder having a contact member for contacting a terminal of the IC chip, which is disposed in an image forming apparatus main body.

6. The cartridge according to claim 5, wherein
a helical projection is formed on an inner peripheral surface of the toner container so that toner within the toner container moves toward the toner discharge port due to rotation of the toner cartridge.

7. The cartridge according to claim 5, wherein
the notch of the annular IC chip holder is substantially L-shaped in a cross section perpendicular to a rotating shaft of the toner cartridge.

8. The cartridge according to claim 5, wherein
the IC chip holder is attached to the bottom through a brush.

9. The cartridge according to claim 5, wherein
the IC chip holder is attached to a rotating shaft of the toner container through a spring.

10. An image forming apparatus, comprising:
a developing device that forms a toner image on an electrostatic latent image formed on an image carrier;
a toner cartridge including a toner cartridge main body having a cylindrical toner container that contains toner to be supplied to the developing device therein, a toner discharge port provided at one end of the toner container, and a rotating shaft disposed at the other end of the toner container, and an annular IC chip holder that is fitted to the rotating shaft of the toner cartridge main body to rotate together with the toner cartridge main body, and has an outer peripheral surface formed with a notch in which an IC chip is mountable;
a toner cartridge holding part that holds the toner cartridge so as to be detachable and rotatable about a center axis of the cylindrical toner container; and
an IC chip contact holder including a step that is fixed to the toner cartridge holding part, and stops rotation of the IC chip holder when being engaged with the notch of the IC chip holder during rotation of the IC chip holder, and a contact member for contacting a terminal of the IC chip.

11. The apparatus according to claim 10, wherein
a helical projection is formed on an inner peripheral surface of the toner container so that toner within the toner container moves toward the toner discharge port due to rotation of the toner cartridge.

12. The apparatus according to claim 10, wherein
the notch of the annular IC chip holder is substantially L-shaped in a cross section perpendicular to a rotating shaft of the toner cartridge.

13. The apparatus according to claim 10, wherein
the IC chip holder is attached to a rotating shaft of the toner container through a torque limiter.

14. The apparatus according to claim 10, wherein
an interior of the rotating shaft is hollow, communicates with an interior of the toner container, and the toner can be contained in the interior of the rotating shaft.

15. The apparatus according to claim 14, wherein
a helical projection is formed on an inner peripheral surface of the toner container so that toner within the toner container moves toward the toner discharge port due to rotation of the toner cartridge.

16. The apparatus according to claim 14, wherein
the notch of the annular IC chip holder is substantially L-shaped in a cross section perpendicular to a rotating shaft of the toner cartridge.

17. The apparatus according to claim 14, wherein
the IC chip holder is attached to the bottom through a brush.

18. The apparatus according to claim 14, wherein
the IC chip holder is attached to a rotating shaft of the toner container through a spring.

19. A toner cartridge used in the apparatus of claim 10, comprising:
a toner cartridge main body having a cylindrical toner container that contains toner therein, a toner discharge port provided at one end of the toner container, and a rotating shaft disposed at the other end of the toner container; and
an annular IC chip holder that is fitted to the rotating shaft of the toner cartridge main body to rotate together with the toner cartridge main body, and has an outer peripheral surface formed with a notch in which an IC chip is mountable.

20. The cartridge used in the apparatus of claim 14, wherein
a toner cartridge main body including a cylindrical toner container that contains toner therein, a toner discharge port provided at one end of the toner container, and a rotating shaft disposed at the other end of the toner container, in which an interior of the rotating shaft is hollow, and communicates with an interior of the toner container; and
an annular IC chip holder that is fitted to the rotating shaft of the toner cartridge main body to rotate together with the toner cartridge main body, and has a notch formed on an outer periphery thereof in which an IC chip is mounted.
